(19) United States
(12) Patent Application Publication
(10) Pub. No.: US 2009/0267719 A1
(43) Pub. Date: Oct. 29, 2009

(54) SPLITTER

(76) Inventors: Hung-Chieh Tseng, Taoyuan Hsien (TW); Ying-Chian Kang, Taoyuan Hsien (TW); Tsung-Hsien Lee, Taoyuan Hsien (TW); Shu-Hui Chen, Taoyuan Hsien (TW); Hua-Sheng Shih, Taoyuan Hsien (TW)

Correspondence Address: Muncy, Geissler, Olds & Lowe, PLLC, P.O. BOX 1364, FAIRFAX, VA, 22038-1364, US

(21) Appl. No.: 12/191,778

(22) Filed: Aug. 14, 2008

(30) Foreign Application Priority Data
Apr. 25, 2008 (TW) 97115308

(51) Int. Cl. H01F 27/02

(52) U.S. Cl. 336/83

(57) ABSTRACT

The present invention provides a splitter including a seat, a first inner core, a second inner core, a first coil, an outer core and a second coil. The seat has a bobbin, and the first coil is wound on the bobbin. The first inner core and the second inner core, disposed on the bobbin, are assembled with each other to cover the bobbin. The outer core and the first inner core are assembled with each other. The second coil is disposed between the outer core and the first inner core.

This Application claims priority of Taiwan Patent Application No. 97115308, filed on Apr. 25, 2008, the entirety of which is incorporated by reference herein.

### BACKGROUND OF THE INVENTION

1. Field of the Invention

The present invention relates to a splitter, and in particular, to a splitter featuring a small size.

2. Description of the Related Art

In telecommunication devices, noises or interferences may come with the transmission of signals. Therefore, multiple inductors are applied as splitters in circuits to filter out noises or interferences.

Two or more single packaged inductors can be found in the retail market, respectively disposed on a circuit board of a telecommunication device. The connection between each inductor is completed by a circuit. However, each inductor must have independent core sets, a bobbin, coils and filler material. Accordingly, the cost and the size of the inductor cannot be reduced, resulting in a high cost and a large sized conventional splitter.

Additionally, each inductor is packaged separately, so that an independent core is required to form the structure. Further, working distances must be kept between the inductors to avoid interferences. Overall, it is not possible to reduce the size of the splitter, and thus not suitable to be applied in miniaturized devices.

### BRIEF SUMMARY OF THE INVENTION

Accordingly, the present invention provides a splitter utilizing fewer components to form a comparatively small sized structure; thus, minimizing the overall size of the device which comprises the splitter.

The invention provides a splitter for firmly positioning and fixing the coil and the core.

The invention provides a splitter comprising a seat, a first inner core, a second inner core, a first coil, a first outer core and a second coil. The seat has a bobbin, and the first coil is wound on the bobbin. The first inner core and the second inner core, disposed on the seat, are assembled to form a magnetic loop of the first coil. The first outer core is assembled with the first inner core, and the second coil is disposed inside the first outer core.

The splitter further comprises a second outer core and a third coil. The second outer core is assembled with the second inner core, and the third coil is disposed inside the second outer core. Further, the splitter comprises one or more then one third outer core and one or more fourth coil. The third outer core is disposed outside the first outer core or outer side of the second outer core, and the fourth coil is disposed inside the third outer core. Meanwhile, the second coil, the third coil and/or the fourth coil is a self-adhesive coil.

The splitter comprises a circuit board coupled to the first coil and/or the second coil. In the splitter, the seat further comprises at least one pin, and the first coil and/or the second coil is connected to the circuit board by the pin. In addition, the seat comprises a positioning recess for positioning and guiding the first inner core, the second inner core or the first outer core.

In the splitter, the first inner core, the second inner core or the first outer core is an E-shaped core, an I-shaped core, a U-shaped core, a P-shaped core or an RM-shaped core such as an EE core, an EP core, an RM core, an EI core, an ER core, a POT core, an EFD core, an EC core, an EPO core, an EPX core, an EQ core, an ELP core, an ETD core, a UI core, an E core or a PQ core. The first inner core, the second inner core or the first outer core are identical in shape. The first inner core, the second inner core and the first outer core are disposed horizontally or vertically.

As described, the two adjacent coils of the splitter share a portion of the core to minimize the size of the component and the splitter. Thus, the device which comprises the splitter is therefore reduced in size. Meanwhile, the splitter comprises a fixed bobbin, allowing the coil and the inner core to be firmly positioned and fixed on the seat. Moreover, other coils and outer cores can also be positioned and fixed by the positioning recess of the seat.

### BRIEF DESCRIPTION OF THE DRAWINGS

The present invention can be more fully understood by reading the subsequent detailed description and examples with references made to the accompanying drawings, wherein:

FIG. 1 is a schematic view of a splitter of an embodiment of the invention.

### DETAILED DESCRIPTION OF THE INVENTION

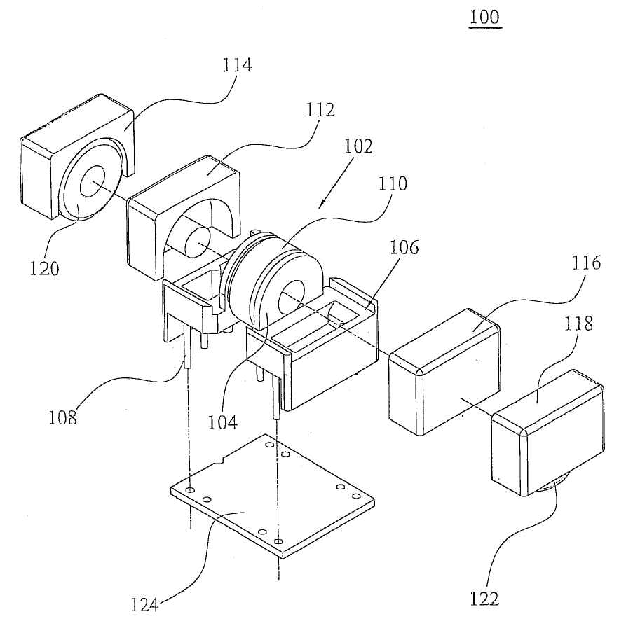

FIG. 1 is a schematic view of a splitter 100 of an embodiment of the invention. The splitter 100 comprises a seat 102, a first inner core 112, a second inner core 116, a first coil 110, a second coil 120, a third coil 122, a first outer core 114 and a second outer core 118. The number of outer cores and the number of coils within the outer core of the splitter 100 may vary according to requirement.

The seat 102 has one or more bobbin 104 and a positioning recess 106. The bobbin 104 is for winding a coil 110. The positioning recess 106 is for positioning and guiding the first inner core 112, the second inner core 116, the first outer core 114, the second outer core 118 and etc. The seat 102 comprises at least one pin 108, and the first coil 110, the second coil 120 and the third coil 122 are electrically connected to the circuit board 124 by the pin 108. The pin 108 can be a single structure, or it can be formed on the ends of the first coil 110, the second coil 120 and third coil 122. The first coil 110, the second coil 120, the third coil 122 or a fourth coil is a self-adhesive coil or a coil wound on the bobbin 104.

The first inner core 112, the second inner core 116, the first outer core 114 and the second outer core 118 are assembled on the seat 102. The first inner core 112 is assembled with the second inner core 116 to form a magnetic loop of the first coil 110. The first outer core 114 and the second outer core 118, respectively disposed on outer sides of the first inner core 112 and the second inner core 116, are assembled with the first inner core 112 and the second inner core 116, respectively. The second coil 120 is disposed inside the first outer core 114, and the third coil 122 is disposed inside the second outer core 118. Specifically, the second coil 120 is disposed between the first outer core 114 and the first inner core 112, and the third coil 122 is disposed between the second outer core 118 and the second inner core 116.

Meanwhile, the splitter 100 is kept small in size and may comprise at least three inductors to fulfill a small-sized multiport connector.

If required, one or more additional outer cores and corresponding coils are disposed on outer sides of the first outer core 114 and the second outer core 118 to form a small-sized splitter with more inductors, thus reducing the size of the device utilizing the splitter. For example, in a splitter comprising the first outer core 114 or the second outer core 118, one or more third outer cores are added outside the first outer core 114 or the second outer core 118, and one or more fourth coils are disposed inside the third outer cores.

The first inner core 112, the second inner core 116, the first outer core 114, the second outer core 118 and the third outer core is an E-shaped core, an I-shaped core, a U-shaped core, a P-shaped core or an RM-shaped core such as an EE core, an EP core, an RM core, an EI core, an ER core, a POT core, an EFD core, an EC core, an EPO core, an EPX core, an EQ core, an ELP core, an ETD core, a UI core, an E core or a PQ core, wherein the first inner core 112, the second inner core 116, the first outer core 114, the second outer core 118 and the third outer core can be identical in shape. The first inner core 112, the second inner core 116, the first outer core 114, the second outer core 118 and/or the third outer core is disposed horizontally or vertically.

Accordingly, the two adjacent coils of the splitter in the invention share a portion of the core to minimize the size of the component and the splitter; thus, reducing the size of the device which comprises the splitter. Meanwhile, the splitter comprises a fixed bobbin, allowing the coil and the inner core to be firmly positioned and fixed on the seat. Moreover, other coils and outer cores can also be positioned and fixed by the positioning recess of the seat.

While the present invention has been described by way of example and in terms of preferred embodiment, it is to be understood that the present invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A splitter comprising
a seat having at least one winding portion;
a first coil wound on the winding portion;
a first inner core disposed on the seat;
a second inner core disposed on the seat, the first inner core and the second inner core assembled to form a magnetic loop of the first coil;
a first outer core assembled with the first inner core; and
a second coil disposed inside the first outer core.

2. The splitter as claimed in claim 1, further comprising:
a second outer core assembled with the second inner core; and
a third coil disposed inside the second outer core.

3. The splitter as claimed in claim 2, wherein the first coil, the second coil or the third coil is a self-adhesive coil or a coil wound on the winding portion.

4. The splitter as claimed in claim 2, further comprising:
one or more third outer core disposed outside the first outer core or the second outer core; and
one or more fourth coil disposed inside the third outer core.

5. The splitter as claimed in claims 4, wherein the fourth coil is a self-adhesive coil or a coil wound on the winding portion.

6. The splitter as claimed in claim 1, further comprising:
one or more third outer core disposed outside the first outer core; and
one or more fourth coil disposed inside the third outer core.

7. The splitter as claimed in claims 6, wherein the fourth coil is a self-adhesive coil or a coil wound on the winding portion.

8. The splitter as claimed in claims 1, further comprising a circuit board coupled to the first coil and/or the second coil.

9. The splitter as claimed in claim 8, wherein the seat further comprises at least one pin, the first coil and/or the second coil is coupled to the circuit board by the pin, and the pin is an independent structure or formed on an end of the first coil and/or the second coil.

10. The splitter as claimed in claim 1, wherein the first coil or the second coil is a self-adhesive coil or a coil wound on the winding portion.

11. The splitter as claimed in claim 1, wherein the seat comprises at least one positioning recess for positioning and guiding the first inner core, the second inner core or the first outer core.

12. The splitter as claimed in claim 1, wherein the first inner core, the second inner core or the first outer core is an E-shaped core, an I-shaped core, a U-shaped core, a P-shaped core or an RM-shaped core.

13. The splitter as claimed in claim 1, wherein the first inner core, the second inner core or the first outer core is an EE core, an EP core, an RM core, an EI core, an ER core, a POT core, an EFD core, an EC core, an EPO core, an EPX core, an EQ core, an ELP core, an ETD core, a UI core, an E core or a PQ core.

14. The splitter as claimed in claim 1, wherein the first inner core, the second inner core or the first outer core are identical in shape.

15. The splitter as claimed in claim 1, wherein the first inner core, the second inner core and the first outer core are disposed horizontally or vertically.
